(19) United States
(12) Patent Application Publication
(10) Pub. No.: US 2023/0163810 A1
(43) Pub. Date: May 25, 2023

(54) METHOD AND DEVICE USED FOR WIRELESS COMMUNICATION

(71) Applicants: Jinfang ZHANG, SHANGHAI (CN); Xiaobo ZHANG, SHANGHAI (CN)

(72) Inventors: Jinfang ZHANG, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/990,728

(22) Filed: Nov. 20, 2022

(30) Foreign Application Priority Data
Nov. 25, 2021 (CN) 202111412539.4

(51) Int. Cl. H04B 7/024

(52) U.S. Cl. CPC H04B 7/024

(57) ABSTRACT

The present application provides a method and device for wireless communications. A first node at least transmits a first data unit set via a first air interface; receives a first message via the first air interface, the first message being used to determine that at least the first data unit set is correctly received; at least transmits the first data unit set to a second node through a first backhaul link; transmits a second message via a second air interface, the second message being used to indicate the first data unit set; wherein the second node is co-located with a receiver of the second message, and the second node and the receiver of the second message are respectively not co-located with a transmitter of the first message. The present application effectively supports the coordinated transmission between base stations.

### CROSS REFERENCE TO RELATED APPLICATIONS

This application claims the priority benefit of Chinese Patent Application No. 202111412539.4, filed on Nov. 25, 2021, the full disclosure of which is incorporated herein by reference.

### BACKGROUND

### Technical Field

The present application relates to methods and devices in wireless communication systems, and in particular to a method and device for coordinated transmission of base stations in wireless communications.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72 plenary decided to conduct the study of New Radio (NR), or what is called fifth Generation (5G). The work Item (WI) of NR was approved at 3GPP RAN #75 plenary to standardize the NR.

Coordinated transmission of base stations is a transmission technology in cellular networks, a UE with multiple Receiver/Transmitter (Rx/Tx) capabilities is configured to perform receptions with resources provided by two different base stations connected by a non-ideal backhaul link, data received repeatedly is dropped at the UE, therefore, coordinated transmission of the base stations can effectively improve the transmission reliability.

### SUMMARY

Inventors have found through researches that during the coordinated transmission of the base stations, information interaction between base stations is delayed due to a non-ideal backhaul link, therefore, the information interacted between base stations cannot be used for coordination between base stations with high real-time requirements. Also, an Xn interface between the base stations adds transmission redundancy.

The present application discloses a solution that can effectively reduce the transmission delay between two coordinated base stations by indicating whether user data has been successfully received or not via an air interface. Although the present application was originally intended for a Uu air interface, it can also be applied to a PC5 air interface. Additionally, the adoption of a unified solution for various scenarios, including but not limited to uplink communication scenarios, contributes to the reduction of hardware complexity and costs. If no conflict is incurred, embodiments in the first node in the present application and the characteristics of the embodiments are also applicable to any other node, and vice versa. And the embodiments in the present application and the characteristics in the embodiments can be arbitrarily combined if there is no conflict. Particularly, for interpretations of the terminology, nouns, functions and variants (if not specified) in the present application, refer to definitions given in TS36 series, TS38 series and TS37 series of 3GPP specifications.

The present application provides a method in a first node for wireless communications, comprising:

at least transmitting a first data unit set via a first air interface;

receiving a first message via the first air interface, the first message being used to determine that at least the first data unit set is correctly received;

at least transmitting the first data unit set to a second node through a first backhaul link; and

transmitting a second message via a second air interface, the second message being used to indicate the first data unit set;

herein, the second node is co-located with a receiver of the second message, and the second node and the receiver of the second message are respectively not co-located with a transmitter of the first message.

In one embodiment, the above method transmits the second message via an air interface, which significantly reduces the transmission delay.

In one embodiment, the above method transmits the second message via an air interface, which significantly reduces the redundancy overhead.

In one embodiment, the above method transmits the second message via an air interface, which helps to achieve a closer inter-cell coordination between the first node and the second node.

In one embodiment, at least the second message is used to optimize scheduling of the receiver of the second message.

In one embodiment, at least the second message is used to determine whether at least one data unit in the first data unit set is transmitted by the second node at a third air interface.

In one embodiment, at least the second message is used to determine whether at least one data unit in the first data unit set is transmitted by a cell maintained by the second node at a third air interface.

In one embodiment, at least the second message is used to determine whether a transmission of at least one data unit in the first data unit set is delayed at the third air interface.

In one embodiment, the third air interface is a third air link.

In one embodiment, the third air interface is an air interface between the second node and a user in a cell maintained by the second node.

In one embodiment, the third air interface is an NR air interface.

In one embodiment, the third air interface is an NR-RAN air interface.

In one embodiment, the third air interface is a 5G air interface.

In one embodiment, at least the second message is used to clear cache used for storing the first data unit set in the second node in advance.

According to one aspect of the present application, comprising:

receiving a third message via the second air interface, the third message being used to determine that at least a second data unit set is correctly received;

determining whether at least one data unit in the second data unit set is transmitted via the first air interface according to at least the third message;

herein, the second data unit set is transmitted by the first processor to the second node through the first backhaul link.

In one embodiment, the above method transmits the third message via an air interface, which significantly reduces the transmission delay.

In one embodiment, the above method transmits the third message via an air interface, which significantly reduces the redundancy overhead.

In one embodiment, the above method transmits the third message via an air interface, which helps to achieve a closer inter-cell coordination between the first node and the second node.

According to one aspect of the present application, comprising:

transmitting a fourth message through the first backhaul link, and the fourth message being used to indicate a first candidate resource set;

herein, resources occupied by transmitting the second message belong to the first candidate resource set.

According to one aspect of the present application, comprising:

receiving a fifth message through the first backhaul link, the fifth message being a response to the fourth message;

herein, the fifth message is used to indicate a second candidate resource set, the second candidate resource set is a subset of the first candidate resource set, and the second candidate resource set is reserved for a transmission through the second air interface.

In one embodiment, the fourth message and the fifth message are used to negotiate resources transmitted by the first node and the second node through the second air interface.

In one embodiment, the above method negotiates radio resources occupied by the second message in advance, which can reduce the transmission delay.

According to one aspect of the present application, comprising:

a first data unit being used to determine time-domain resources occupied by transmitting the second message;

herein, the first data unit is a data unit with a minimum sequence number in the first data unit set.

According to one aspect of the present application, comprising:

transmitting a first signaling via the first air interface, the first signaling being used to indicate that a data unit belonging to a first radio bearer is simultaneously received from the first node and the second node;

herein, the first data unit set belongs to the first radio bearer.

In one embodiment, the present application is applicable to a scenario where one node receives data from two different nodes at the same time.

The present application provides a first node for wireless communications, comprising:

a first transmitter, at least transmitting a first data unit set via a first air interface;

a first receiver, receiving a first message via the first air interface, the first message being used to determine that at least the first data unit set is correctly received;

a first processor, at least transmitting the first data unit set to a second node through a first backhaul link;

the first transmitter, transmitting a second message via a second air interface, the second message being used to indicate the first data unit set;

herein, the second node is co-located with a receiver of the second message, and the second node and the receiver of the second message are respectively not co-located with a transmitter of the first message.

The present application provides a method in a second node for wireless communications, comprising:

at least receiving a first data unit set from a first node through a first backhaul link;

receiving a second message via a second air interface, the second message being used to indicate the first data unit set;

herein, at least the first data unit set is transmitted by the first node via a first air interface; a first message is received by the first node via the first air interface, and the first message is used to determine that at least the first data unit set is correctly received; the first node and a transmitter of the second message are co-located; the second node and a transmitter of the first message are not co-located.

According to one aspect of the present application, comprising:

transmitting a third message via the second air interface, the third message being used to determine that at least a second data unit set is correctly received;

herein, at least the third message is used to determine whether at least one data unit in the second data unit set is transmitted by the first node via the first air interface; the second data unit set is transmitted by the first node to the second node through the first backhaul link.

According to one aspect of the present application, comprising:

receiving a fourth message through the first backhaul link, and the fourth message being used to indicate a first candidate resource set;

herein, resources occupied by transmitting the second message belong to the first candidate resource set.

According to one aspect of the present application, comprising:

transmitting a fifth message through the first backhaul link, and the fifth message being a response to the fourth message;

herein, the fifth message is used to indicate a second candidate resource set, the second candidate resource set is a subset of the first candidate resource set, and the second candidate resource set is reserved for a transmission through the second air interface.

According to one aspect of the present application, comprising:

a first data unit being used to determine time-domain resources occupied by transmitting the second message;

herein, the first data unit is a data unit with a minimum sequence number in the first data unit set.

According to one aspect of the present application, comprising:

a first signaling being transmitted by the first node via the first air interface, the first signaling being used to indicate that a data unit belonging to a first radio bearer is simultaneously received from the first node and the second node;

herein, the first data unit set belongs to the first radio bearer; a receiver of the first signaling and the transmitter of the first message are co-located.

The present application provides a second node for wireless communications, comprising:

a fourth processor, at least receiving a first data unit set from a first node through a first backhaul link;

a second receiver, receiving a second message via a second air interface, the second message being used to indicate the first data unit set;

herein, at least the first data unit set is transmitted by the first node via a first air interface; a first message is received by the first node via the first air interface, and the first message is used to determine that at least the first data unit set is correctly received; the first node and a transmitter of the second message are co-located; the second node and a transmitter of the first message are not co-located.

The present application provides a method in a third node for wireless communications, comprising:

at least receiving a first data unit set via a first air interface;

transmitting a first message via the first air interface, the first message being used to determine that at least the first data unit set is correctly received;

herein, at least the first data unit set is transmitted by a first node to a second node through a first backhaul link; a second message is transmitted by the first node through a second air interface, and the second message is used to indicate the first data unit set; the second node is co-located with a receiver of the second message, and the second node and the receiver of the second message are respectively not co-located with the third node, and a receiver of the first message is the first node.

According to one aspect of the present application, comprising:

a third message is received by the first node through the second air interface, the third message being used to determine that at least a second data unit set is correctly received; at least the third message is used to determine whether at least one data unit in the second data unit set is transmitted by the first node via the first air interface;

herein, the second data unit set is transmitted by the first node to the second node through the first backhaul link; a transmitter of the third message and the receiver of the second message are co-located.

According to one aspect of the present application, comprising:

a fourth message is transmitted by the first node to the second node through the first backhaul link, and the fourth message being used to indicate a first candidate resource set;

herein, resources occupied by transmitting the second message belong to the first candidate resource set.

According to one aspect of the present application, comprising:

a fifth message is transmitted by the second node to the first node through the first backhaul link, and the fifth message being a response to the fourth message;

herein, the fifth message is used to indicate a second candidate resource set, the second candidate resource set is a subset of the first candidate resource set, and the second candidate resource set is reserved for a transmission through the second air interface.

According to one aspect of the present application, comprising:

a first data unit being used to determine time-domain resources occupied by transmitting the second message;

herein, the first data unit is a data unit with a minimum sequence number in the first data unit set.

According to one aspect of the present application, comprising:

receiving a first signaling via the first air interface, the first signaling being used to indicate that a data unit belonging to a first radio bearer is simultaneously received from the first node and the second node;

herein, the first data unit set belongs to the first radio bearer.

The present application provides a third node for wireless communications, comprising:

a first receiver, at least receiving a first data unit set via a first air interface;

a third transmitter, transmitting a first message via the first air interface, the first message being used to determine that at least the first data unit set is correctly received;

herein, at least the first data unit set is transmitted by a first node to a second node through a first backhaul link; a second message is transmitted by the first node through a second air interface, and the second message is used to indicate the first data unit set; the second node is co-located with a receiver of the second message, and the second node and the receiver of the second message are respectively not co-located with the third node, and a receiver of the first message is the first node.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of hardware modules of a communication device according to one embodiment of the present application;

FIG. 5 illustrates a flowchart of radio signal transmission according to one embodiment of the present application;

FIG. 6 illustrates a flowchart of signal transmission on a first backhaul link according to one embodiment of the present application;

FIG. 7 illustrates a schematic diagram of a format of a second message according to one embodiment of the present application;

FIG. 8 illustrates a schematic diagram of a connection between a first node and a second node according to one embodiment of the present application;

FIG. 9 illustrates a schematic diagram of a second air interface according to one embodiment of the present application;

FIG. 10 illustrates a structure block diagram of a processor in a first node according to one embodiment of the present application;

FIG. 11 illustrates a structure block diagram of a processor in a second node according to one embodiment of the present application;

FIG. 12 illustrates a structure block diagram of a processor in a third node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of transmission of a first node according to one embodiment of the present application, as shown in FIG. 1.

In Embodiment 1, a first node 100 at least transmits a first data unit set via a first air interface in step 101; receives a first message via the first air interface in step 102, the first message being used to determine that at least the first data unit set is correctly received; at least transmits the first data unit set to a second node through a first backhaul link in step 103; transmits a second message via a second air interface in step 104, the second message being used to indicate the first data unit set; herein, the second node is co-located with a receiver of the second message, and the second node and the receiver of the second message are respectively not co-located with a transmitter of the first message. It is particularly underlined that the order illustrated in the embodiment does not put constraints over sequences of signal transmissions and implementations. Specifically, step 103 may precede step 101, or step 103 may be executed simultaneously with step 101 and step 102.

In one embodiment, at least a first data unit set is transmitted via a first air interface, and the first data unit set comprises at least one data unit.

In one embodiment, control information is transmitted via the first air interface.

In one embodiment, a broadcast message is transmitted via the first air interface.

In one embodiment, the first air interface is a first air link.

In one embodiment, the first air interface is an air interface between the first node and a user in a cell maintained by the first node.

In one embodiment, the first air interface is an NR air interface.

In one embodiment, the first air interface is an NR-RAN air interface.

In one embodiment, the first air interface is a 5G air interface.

In one embodiment, the first air interface is a Uu interface.

In one embodiment, any data unit in the first data unit set is a Packet Data Convergence Protocol (PDCP) Service Data Unit (SDU).

In one subembodiment of the above embodiment, at least the first data unit set is received from a Service Data Adaptation Protocol (SDAP) sublayer of the first node.

In one subembodiment of the above embodiment, at least the first data unit set is received from a Radio Resource Control (RRC) sublayer of the first node.

In one embodiment, any data unit in the first data unit set is a Radio Link Control (RLC) SDU.

In one subembodiment of the above embodiment, at least the first data unit set is received from a PDCP sublayer of the first node.

In one embodiment, each data unit in the first data unit set is transmitted in the first air interface after being processed by RLC sublayer, MAC sublayer and PHY layer protocols.

In one embodiment, a first message is received via the first air interface, the first message is used to determine that at least the first data unit set is correctly received.

In one embodiment, the first message is an RLC sub-layer message.

In one embodiment, the first message is an RLC control Protocol Data Unit (PDU).

In one embodiment, the first message is an RLC STATUS PDU.

In one embodiment, the first message is a PDCP sublayer message.

In one embodiment, the first message is a PDCP control PDU.

In one embodiment, the first message is a PDCP status report.

In one embodiment, the first message is used to determine that a data unit other than the first data unit set is not correctly received.

In one embodiment, the first message is used to determine that at least partial bits in a data unit other than the first data unit set is not correctly received.

In one embodiment, the first message is received at a PDCP sublayer of the first node, the first message is PDCP status report, and any data unit in the first data unit set is a PDCP SDU.

In one embodiment, after being received at an RLC sublayer of the first node, the first message indicates to a PDCP sublayer of the first node; herein, the first message is an RLC STATUS PDU, and any data unit in the first data unit set is a PDCP SDU.

In one embodiment, an RLC sublayer of the first node indicates to a PDCP sublayer of the first node a successful transmission of an RLC SDU set; herein, an RLC SDU in the RLC SDU set consists of a PDCP SDU and a corresponding PDCP header; herein, the PDCP SDU belongs to the first data unit set, and the PDCP header is used to indicate a sequence number of a corresponding PDCP SDU.

The above embodiments enable a PDCP sublayer of the first node to obtain a sequence number of a successfully received PDCP SDU.

In one embodiment, the first backhaul link connects the first node and the second node.

In one embodiment, the first backhaul link is a wired link.

In one embodiment, the first backhaul link is a microwave link.

In one embodiment, the first backhaul link supports an Xn interface.

In one embodiment, at least the first data unit set is transmitted through the first backhaul link to a second node.

In one embodiment, at least the first data unit set is transmitted through the first backhaul link to a corresponding protocol sublayer of the second node.

In one embodiment, the corresponding protocol sublayer comprises: a protocol layer of the first data unit set at the first node is the same as a protocol layer of the first data unit set at the second node.

In one embodiment, each data unit in the first data unit set and a sequence number of the each data unit are transmitted through the first backhaul link to the second node.

In one embodiment, a first radio bearer identifier is transmitted through the first backhaul link, and each data unit in the first data unit set and a sequence number of the each data unit is transmitted to the second node.

In one embodiment, the sequence number is COUNT, and the COUNT consists of a Hyper Frame Number (HFN) and a PDCP sequence number.

In one embodiment, the second air interface is a second air link.

In one embodiment, the second message is not an Xn Application Protocol (XnAP) message.

In one embodiment, the second message is not transmitted through an Xn interface.

In one embodiment, the second message is a MAC sublayer message.

In one embodiment, the second message is a PHY layer message.

In one embodiment, the second message is a PDCP sublayer message.

In one embodiment, the second message is an RLC sublayer message.

In one embodiment, the second message is transmitted through Physical Backhaul Shared CHannel (PBSCH).

In one embodiment, as a response to receiving the first message, the second message is transmitted.

In one embodiment, at least the first message is used to generate the second message.

In one embodiment, the second message is used to indicate the first data unit set.

In one embodiment, the second node is co-located with a receiver of the second message.

In one embodiment, the phrase of the second node being co-located with a receiver of the second message comprises: the second node and a receiver of the second message is a same base station.

In one embodiment, the phrase of the second node being co-located with a receiver of the second message comprises: the second node and a receiver of the second message is a same node.

In one embodiment, the phrase of the second node being co-located with a receiver of the second message comprises: a signal transmitted by the second node is Quasi-CoLocated with a signal transmitted by a receiver of the second message.

In one embodiment, the specific meaning of the QCL can be found in 3GPP TS38.214, section 5.1.5.

In one embodiment, a signal being QCL with another signal comprises: all or partial large-scale properties of a radio signal transmitted on an antenna port corresponding to a signal can be used to infer all or partial large-scale properties of a radio signal transmitted on an antenna port corresponding to another signal.

In one embodiment, large-scale properties of a radio signal comprise at least one of delay spread, Doppler spread, Doppler shift, path loss, average gain, average delay or Spatial Rx parameters.

In one embodiment, Spatial Rx parameters comprise at least one of a receiving beam, a receiving analog beamforming matrix, a receiving analog beamforming vector, a receiving beamforming vector, a receiving spatial filter or a spatial domain reception filter.

In one embodiment, the second node and the receiver of the second message are respectively not co-located with a transmitter of the first message.

In one embodiment, the second node and the transmitter of the first message are not co-located.

In one embodiment, the receiver of the second message and the transmitter of the first message are not co-located.

In one embodiment, the phrase of the second node and the receiver of the second message being respectively not co-located with a transmitter of the first message comprises: the second node and a transmitter of the first message are not a same node; the receiver of the second message and the transmitter of the first message are not a same node.

In one embodiment, the phrase of the second node and the receiver of the second message being respectively not co-located with a transmitter of the first message comprises: the second node and the receiver of the second message are a same base station; the transmitter of the first message is a UE.

### Embodiment 2

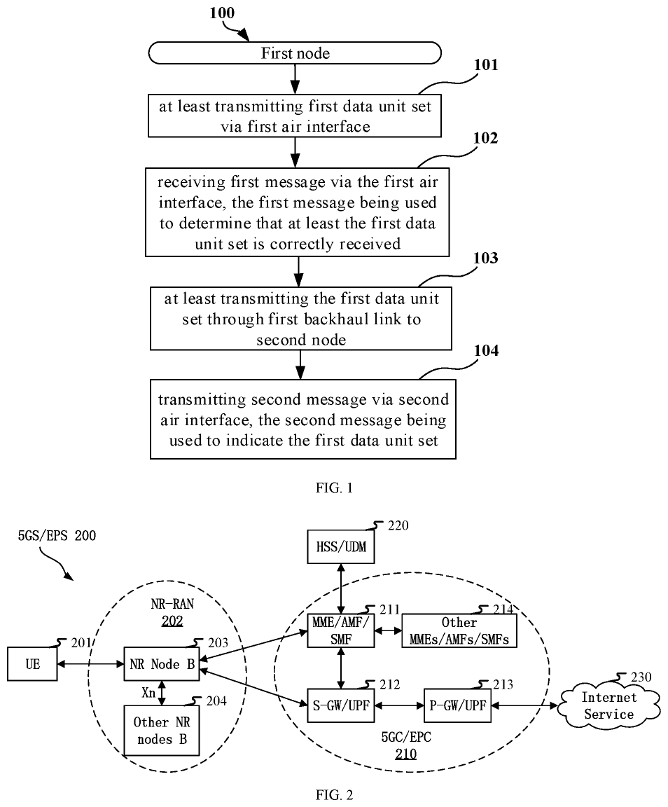

Embodiment 2 illustrates a schematic diagram of a network architecture according to one embodiment of the present application, as shown in FIG. 2. FIG. 2 is a diagram illustrating a network architecture 200 of 5G NR, Long-Term Evolution (LTE), and Long-Term Evolution Advanced (LTE-A) systems. The NR 5G, LTE or LTE-A network architecture 200 may be called a 5G System (5GS)/Evolved Packet System (EPS) 200 or other appropriate terms. The 5GS/EPS 200 may comprise one or more UEs 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). XnAP protocol of Xn interface is used to transmit control plane messages of wireless networks, and user plane protocol of Xn interface is used to transmit user plane data. The gNB 203 may be called a base station, a base transceiver station, a radio base station, a radio transceiver, a transceiver function, a Base Service Set (BSS), an Extended Service Set (ESS), a Transmit-Receive Point (TRP) or some other applicable terms. In NTN network, the gNB 203 may be a satellite, an aircraft or a territorial base station relayed through a satellite. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, vehicle equipment, On-board communication unit, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the gNB 203 corresponds to the first node in the present application.

In one embodiment, the gNB 204 corresponds to the second node in the present application.

In one embodiment, the UE 201 corresponds to the third node in the present application.

In one embodiment, the gNB 203 or the gNB 204 is a Marco Cell base station.

In one embodiment, the gNB 203 or the gNB 204 is a Micro Cell base station.

In one embodiment, the gNB 203 or the gNB 204 is a Pico Cell base station.

In one embodiment, the gNB 203 or the gNB 204 is a Femtocell.

In one embodiment, the gNB 203 or the gNB 204 is a base station supporting large delay differences.

In one embodiment, the gNB 203 or the gNB 204 is a flight platform equipment.

In one embodiment, the gNB 203 or the gNB 204 is a satellite equipment.

In one embodiment, a radio link from the UE 201 to the gNB 203 or the gNB 204 is an Uplink.

In one embodiment, a radio link from the gNB 203 or the gNB 204 to the UE 201 is a Downlink.

In one embodiment, the UE 201 and the gNB 203 are connected via a Uu interface.

In one embodiment, the UE 201 and the gNB 204 are connected via a Uu interface.

In one embodiment, the gNB 203 and the gNB 204 are connected via an Xn interface.

In one embodiment, the gNB 203 and the gNB 204 are connected via the second air interface.

In one embodiment, at least one of the gNB 203 and the gNB 204 supports Full Duplex.

### Embodiment 3

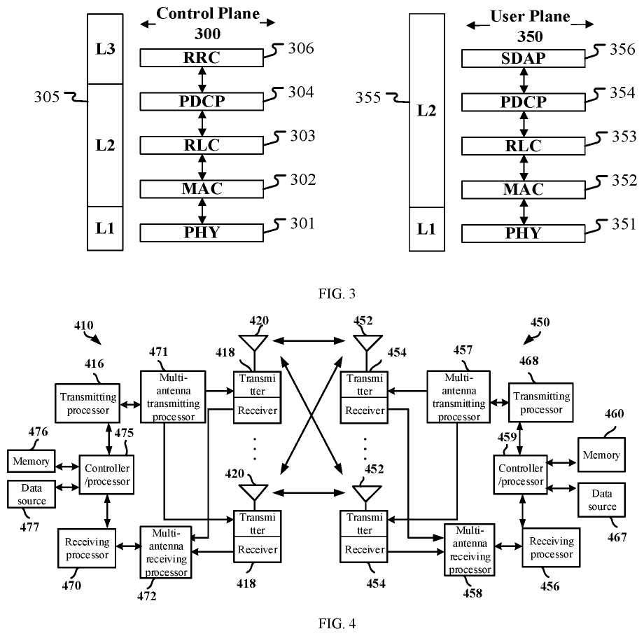

Embodiment 3 illustrates a schematic diagram of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 of a UE and a gNB is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the UE and the gNB via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the gNBs of the network side. The PDCP sublayer 304 provides data encryption and integrity protection and also provides support for a UE handover between gNBs. The RLC sublayer 303 provides segmentation and reassembling of a packet, retransmission of a lost data packet through ARQ, as well as repeat data packet detection and protocol error detection. The MAC sublayer 302 provides mapping between a logic channel and a transport channel and multiplexing of the logical channel ID. The MAC sublayer 302 is also responsible for allocating between UEs various radio resources (i.e., resources block) in a cell. The MAC sublayer 302 is also responsible for Hybrid Automatic Repeat Request (HARQ) operation. The Radio Resource Control (RRC) sublayer 306 in layer 3 (L3) of the control plane 300 is responsible for acquiring radio resources (i.e., radio bearer) and configuring the lower layer with an RRC signaling between the gNB and the UE. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. The radio protocol architecture of the UE in the user plane 350 may comprises part or all of protocol sublayers of the SDAP sublayer 356, the PDCP sublayer 354, the RLC sublayer 353 and the MAC sublayer 352 at L2 layer. Although not described in FIG. 3, the UE may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, entities of multiple sublayers of the control plane in FIG. 3 form a Signaling Radio Bear (SRB) in the vertical direction.

In one embodiment, entities of multiple sublayers of the user plane in FIG. 3 form a Data Radio Bear (DRB) in the vertical direction.

In one embodiment, entities of multiple sublayers of the user plane in FIG. 3 form a MBMS point to multipoint Radio Bearer (MRB) in the vertical direction.

In one embodiment, the first data unit set in the present application is generated at the PDCP 304 and the PDCP 354.

In one embodiment, the first data unit set in the present application is generated at the RLC 303 and the RLC 353.

In one embodiment, the first message in the present application is generated at the PDCP 304 and the PDCP 354.

In one embodiment, the first message in the present application is generated at the RLC 303 and the RLC 353.

In one embodiment, the second message in the present application is generated at the PDCP 304 and the PDCP 354.

In one embodiment, the second message in the present application is generated at the RLC 303 and the RLC 353.

In one embodiment, the second message in the present application is generated by the MAC 302 and the MAC 352.

In one embodiment, the second message in the present application is generated by the PHY 301 and the PHY 351.

In one embodiment, the third message in the present application is generated at the PDCP 304 and the PDCP 354.

In one embodiment, the third message in the present application is generated at the RLC 303 and the RLC 353.

In one embodiment, the third message in the present application is generated by the MAC 302 and the MAC 352.

In one embodiment, the third message in the present application is generated by the PHY 301 and the PHY 351.

In one embodiment, the second data unit set in the present application is generated at the PDCP 304 and the PDCP 354.

In one embodiment, the second data unit set in the present application is generated at the RLC 303 and the RLC 353.

In one embodiment, the fourth message in the present application is generated by the RRC 306.

In one embodiment, the fifth message in the present application is generated by the RRC 306.

In one embodiment, the first signaling in the present application is generated by the RRC 306.

In one embodiment, a sublayer receives an SDU from an upper layer to generate a PDU to be transferred to a lower layer.

In one subembodiment of the above embodiment, the PDCP sublayer receives a PDCP SDU from the SDAP sublayer or the RRC sublayer, and transfers a PDCP PDU to the RLC sublayer.

In one subembodiment of the above embodiment, the RLC sublayer receives an RLC SDU from the PDCP sublayer and transfers an RLC PDU to the MAC sublayer.

In one subembodiment of the above embodiment, the MAC sublayer receives a MAC SDU from the RLC sublayer and transfers a MAC PDU to the PHY layer.

In one embodiment, the L2 layer 305 belongs to a higher layer.

In one embodiment, the RRC sublayer 306 in the L3 layer belongs to a higher layer.

### Embodiment 4

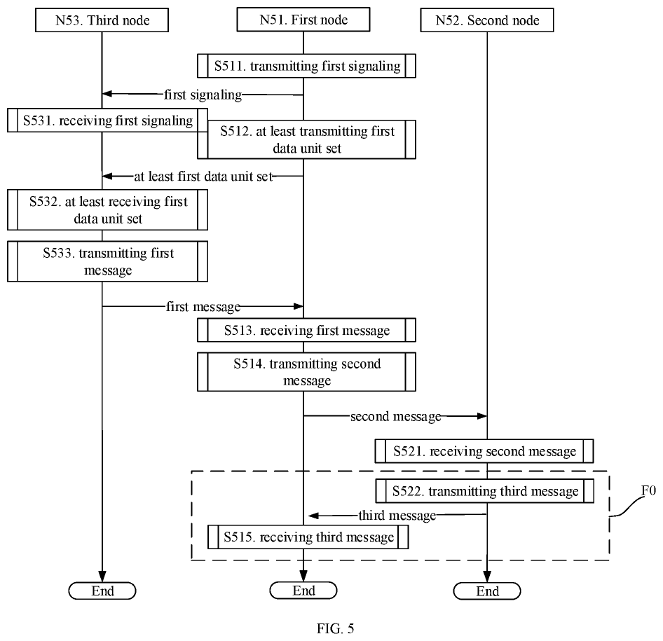

Embodiment 4 illustrates a schematic diagram of hardware modules of a communication device according to one embodiment of the present application, as shown in FIG. 4. FIG. 4 is a block diagram of a first communication device 450 in communications with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a data source 477, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from the core network or a higher layer packet from the data source 477 is provided to the controller/processor 475. The core network and the data source 477 represents all protocol layers above the L2 layer. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In a transmission from the second communication device 410 to the first communication device 450, the controller/processor 459 provides multiplexing between a transport channel and a logical channel, packet reassembling, decryption, header decompression, control signal processing so as to recover a higher-layer packet from the second communication device 410. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the first communication device 450. The higher layer packet from the controller/processor 475 can be provided to all protocol layers above the core network or the L2 layer, and various control signals can also be provided to the core network or L3 layer for L3 layer processing.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: at least receives a first data unit set from a first node through a first backhaul link; and receives a second message via a second air interface, the second message is used to indicate the first data unit set; herein, at least the first data unit set is transmitted by the first node via a first air interface; a first message is received by the first node via the first air interface, and the first message is used to determine that at least the first data unit set is correctly received; the first node and a transmitter of the second message are co-located; the second node and a transmitter of the first message are not co-located.

In one embodiment, the first communication device 450 comprises: a memory that stores a computer readable instruction program. The computer readable instruction program generates an action when executed by at least one processor. The action includes: at least receiving a first data unit set from a first node through a first backhaul link; and receiving a second message via a second air interface, the second message being used to indicate the first data unit set; herein, at least the first data unit set is transmitted by the first node via a first air interface; a first message is received by the first node via the first air interface, and the first message is used to determine that at least the first data unit set is correctly received; the first node and a transmitter of the second message are co-located; the second node and a transmitter of the first message are not co-located.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: at least receives a first data unit set via a first air interface; and transmits a first message via the first air interface, the first message is used to determine that at least the first data unit set is correctly received; herein, at least the first data unit set is transmitted by a first node to a second node through a first backhaul link; a second message is transmitted by the first node through a second air interface, and the second message is used to indicate the first data unit set; the second node is co-located with a receiver of the second message, and the second node and the receiver of the second message are respectively not co-located with the third node, and a receiver of the first message is the first node.

In one embodiment, the first communication device 450 comprises: a memory that stores a computer readable instruction program. The computer readable instruction program generates an action when executed by at least one processor. The action includes: at least receiving a first data unit set via a first air interface; transmitting a first message via the first air interface, the first message being used to determine that at least the first data unit set is correctly received; herein, at least the first data unit set is transmitted by a first node to a second node through a first backhaul link; a second message is transmitted by the first node through a second air interface, and the second message is used to indicate the first data unit set; the second node is co-located with a receiver of the second message, and the second node and the receiver of the second message are respectively not co-located with the third node, and a receiver of the first message is the first node.

In one embodiment, the second communication device 410 comprises at least one processor and at least one memory. The at least one memory comprises computer program codes; the at least one memory and the computer program codes are configured to be used in collaboration with the at least one processor, the first communication device 410 at least: at least transmits a first data unit set via a first air interface; receives a first message via the first air interface, the first message is used to determine that at least the first data unit set is correctly received; at least transmits the first data unit set to a second node through a first backhaul link; and transmits a second message via a second air interface, the second message is used to indicate the first data unit set; herein, the second node is co-located with a receiver of the second message, and the second node and the receiver of the second message are respectively not co-located with a transmitter of the first message.

In one embodiment, the second communication device 410 comprises a memory that stores a computer readable instruction program. The computer readable instruction program generates an action when executed by at least one processor. The action includes: receiving a first signal, the first signaling being associated with a first SSB index, the first signal comprising a random access preamble; at least transmitting a first data unit set via a first air interface; receiving a first message via the first air interface, the first message being used to determine that at least the first data unit set is correctly received; at least transmitting the first data unit set to a second node through a first backhaul link; transmitting a second message via a second air interface, the second message being used to indicate the first data unit set; herein, the second node is co-located with a receiver of the second message, and the second node and the receiver of the second message are respectively not co-located with a transmitter of the first message.

In one embodiment, the second communication device 410 corresponds to a first node in the present application.

In one embodiment, the second node in the present application and the third node in the present application respectively adopts the first communication node 450.

In one embodiment, the first communication device 450 is a UE.

In one embodiment, the first communication device 450 is a base station.

In one embodiment, the second communication device 410 is a base station.

In one embodiment, at least one of the antenna 420, the transmitter 418, the multi-antenna transmitting processor 471, the transmitting processor 416 or the controller/processor 475 is used to at least transmit a first data unit set in the present application.

In one embodiment, at least one of the antenna 452, the receiver 454, the multi-antenna receiving processor 458, the receiving processor 456 or the controller/processor 459 is used to at least receive a first data unit set in the present application.

In one embodiment, at least one of the antenna 452, the transmitter 454, the multi-antenna transmitting processor 457, the transmitting processor 468 or the controller/processor 459 is used to transmit a first message in the present application.

In one embodiment, at least one of the antenna 420, the receiver 418, the multi-antenna receiving processor 472, the receiving processor 470 or the controller/processor 475 is used to receive a first message in the present application.

In one embodiment, at least one of the antenna 420, the transmitter 418, the multi-antenna transmitting processor 471, the transmitting processor 416 or the controller/processor 475 is used to transmit a second message in the present application.

In one embodiment, at least one of the antenna 452, the receiver 454, the multi-antenna receiving processor 458, the receiving processor 456 or the controller/processor 459 is used to receive second message in the present application.

In one embodiment, at least one of the antenna 452, the transmitter 454, the multi-antenna transmitting processor 457, the transmitting processor 468 or the controller/processor 459 is used to transmit a third message in the present application.

In one embodiment, at least one of the antenna 420, the receiver 418, the multi-antenna receiving processor 472, the receiving processor 470 or the controller/processor 475 is used to receive a third message in the present application.

In one embodiment, at least one of the antenna 420, the transmitter 418, the multi-antenna transmitting processor 471, the transmitting processor 416 or the controller/processor 475 is used to transmit a fourth message in the present application.

In one embodiment, at least one of the antenna 452, the receiver 454, the multi-antenna receiving processor 458, the receiving processor 456 or the controller/processor 459 is used to receive a fourth message in the present application.

In one embodiment, at least one of the antenna 452, the transmitter 454, the multi-antenna transmitting processor 457, the transmitting processor 468 or the controller/processor 459 is used to transmit a fifth message in the present application.

In one embodiment, at least one of the antenna 420, the receiver 418, the multi-antenna receiving processor 472, the receiving processor 470 or the controller/processor 475 is used to receive a fifth message in the present application.

In one embodiment, at least one of the antenna 420, the transmitter 418, the multi-antenna transmitting processor 471, the transmitting processor 416 or the controller/processor 475 is used to transmit a first signaling in the present application.

In one embodiment, at least one of the antenna 452, the receiver 454, the multi-antenna receiving processor 458, the receiving processor 456 or the controller/processor 459 is used to receive a first signaling in the present application.

### Embodiment 5

Embodiment 5 illustrates a flowchart of transmission of a radio signal according to one embodiment in the present application, as shown in FIG. 5. A first node and a second node are in communications via a second air interface, and a first node and a third node are in communications via a first air interface, where steps in box F0 are optional. It is particularly underlined that the order illustrated in the embodiment does not put constraints over sequences of signal transmissions and implementations. Specifically, steps in dotted box F0 can be executed between the step S511 and the step S514.

The first node N51 transmits a first signaling in step S511; at least transmits a first data unit set in step S512; receives a first message in step S513; transmits a second message in step S514; and receives a third message in step S515.

The second node N52 receives a second message in step S521; and transmits a third message in step S522.

The third node N53 receives a first signaling in step S531; at least receives a first data unit set in step S532; and transmits first information in step S533.

In embodiment 5, a first data unit set is at least transmitted via a first air interface; a first message is received via the first air interface, the first message being used to determine that at least the first data unit set is correctly received; a second message is transmitted via a second air interface, the second message being used to indicate the first data unit set; herein, the second node is co-located with a receiver of the second message, and the second node and the receiver of the second message are respectively not co-located with a transmitter of the first message; a third message is received via the second air interface, the third message is used to determine that at least a second data unit set is correctly received; whether at least one data unit in the second data unit set is transmitted via the first air interface is determined according to at least the third message; herein, the second data unit set is transmitted by the first processor to the second node through the first backhaul link; a first data unit being used to determine time-domain resources occupied by transmitting the second message; herein, the first data unit is a data unit with a minimum sequence number in the first data unit set; a first signaling is transmitted via the first air interface, the first signaling is used to indicate that a data unit belonging to a first radio bearer is simultaneously received from the first node and the second node; herein, the first data unit set belongs to the first radio bearer.

In one embodiment, the first node is a base station of a serving cell of the third node.

In one embodiment, the first node is a base station of a master cell of the third node.

In one embodiment, the second node is a base station of a serving cell of the third node.

In one embodiment, the second node is a base station of a secondary cell of the third node.

In one embodiment, the first node is co-located with a transmitter of the second message.

In one embodiment, the first node and a transmitter of the second message are a same node.

In one embodiment, the second node and a transmitter of the first message are not co-located.

In one embodiment, the second node and a transmitter of the first message are different nodes.

In one embodiment, the second node and the receiver of the second message are respectively not co-located with the third node.

In one embodiment, a receiver of the first message is the first node.

In one embodiment, a first signaling is transmitted via the first air interface, the first signaling is used to indicate that the third node simultaneously receives a data unit belonging to a first radio bearer from the first node and the second node; herein, the first data unit set belongs to the first radio bearer.

In one embodiment, the first signaling is used to configure that the third node is in E-UTRA NR Dual Connectivity with E-UTRA connected to EPC (EN-DC).

In one embodiment, the first signaling is used to configure that the third node is in E-UTRA NR Dual Connectivity with E-UTRA connected to 5GC (NGEN-DC).

In one embodiment, the first signaling is used to configure that the third node is in NR E-UTRA Dual Connectivity (NE-DC).

In one embodiment, the first signaling is used to configure that the third node is in NR-NR Dual Connectivity (NR-DC).

In one embodiment, the first signaling is used to configure that the third node is in Multi-Radio Dual Connectivity (MR-DC).

In one embodiment, when the third node is in Dual Connectivity (DC), the third node receive a data unit belonging to the first radio bearer from the first node and the second node at the same time.

In one embodiment, the first signaling is used to trigger a Dual Active Protocol Stack (DAPS) handover.

In one embodiment, when the third node executes a DAPS handover, the third node receive a data unit belonging to the first radio bearer from the first node and the second node at the same time.

In one embodiment, the first signaling is a higher-layer signaling.

In one embodiment, the first signaling is an RRC signaling.

In one embodiment, the first signaling is an RRCReconfiguration message.

In one embodiment, the first signaling comprises reconfigurationwithsync.

In one embodiment, the first signaling comprises RadioBearerConfig.

In one embodiment, the first signaling comprises a cell identity, and the cell identity is used to identify the second node.

In one embodiment, the first signaling indicates a first radio bearer.

In one embodiment, the first signaling comprises a first radio bearer identifier, and the first radio bearer identifier is used to identify the first radio bearer.

In one embodiment, the first radio bearer is a DAPS bearer.

In one embodiment, the first radio bearer is a Data Radio Bearer (DRB).

In one embodiment, the first radio bearer is a Signaling Radio Bearer (SRB).

In one embodiment, the first radio bearer is a MBMS Point to Multipoint Radio Bearer (MRB).

In one embodiment, the phrase of the first data unit set belonging to the first radio bearer comprises: any data unit in the first data unit set is identified by a first Logical Channel Identity (LCID); herein, the first LCID identifies a first RLC bearer, and the first RLC bearer is associated with the first radio bearer.

In one embodiment, the second node receives a second message via the second radio interface; herein, the receiver of the second message and the second node are a same node.

In one embodiment, the second node at least determines according to the second message whether at least one data unit in the first data unit set is transmitted in the third air interface.

In one embodiment, whether at least one data unit in the first data unit set is transmitted via the third air interface is determined by the second node itself.

In one embodiment, a first data unit is used to determine time-domain resources occupied by the second message; herein, the first data unit is a data unit with a minimum sequence number in the first data unit set.

In one embodiment, the phrase of a first data unit being used to determine time-domain resources occupied by transmitting the second message comprises: starting a first timer when a first data unit is received from an upper layer of the first node; selecting a time-domain resource for transmitting the second message before the first timer is expired.

In one subembodiment of the above embodiment, the upper layer is one of an SDAP sublayer or an RRC sublayer; the first data unit is a PDCP SDU; the first timer is maintained at a PDCP sublayer.

In one subembodiment of the above embodiment, the upper layer is a PDCP sublayer; the first data unit is an RLC SDU; the first timer is maintained at an RLC sublayer.

In one embodiment, when the first timer is running, the second message is transmitted.

In one embodiment, the second message is transmitted before the first timer is expired.

In one embodiment, time-domain resources occupied by transmitting the second message are not later than an end time of the first timer.

In one embodiment, time-domain resources occupied by transmitting the second message are not later than an expiration time of the first timer.

In one embodiment, the first node selects a time-domain resource by itself for transmitting the second message before the first timer is expired.

In one embodiment, the first node selects a time-domain resource randomly for transmitting the second message before the first timer is expired.

In one embodiment, one time-domain resource comprises at least one Orthogonal Frequency Division Multiplexing (OFDM) symbol.

In one embodiment, one time-domain resource comprises at least one slot.

In one embodiment, one time-domain resource comprises at least one subframe.

In one embodiment, an expiration value of the first timer is configured by a higher layer.

In one embodiment, the expiration value of the first timer is configured by an RRC layer.

In one embodiment, the expiration value of the first timer is determined by the first node itself.

In one embodiment, the expiration value of the first timer is determined by the first node and the second node through negotiation.

In one embodiment, the expiration value of the first timer is configured by the second node.

In one embodiment, the first timer runs according to the following method: setting a value of the first timer as 0 when the first timer is started, and increasing a value of the first timer by 1 in a next time interval; when a value of the first timer is the expiration value of the first timer, the first timer is expired.

In one embodiment, the first timer runs according to the following method: setting a value of the first timer as the expiration value of the first timer when the first timer is started, and decreasing a value of the first timer by 1 in a next time interval; when a value of the first timer is 0, the first timer is expired.

In one embodiment, when the first timer is in a running state, the first timer is updated in each time interval.

In one embodiment, when the first timer is in a stopping state, the first timer is stopped in each time interval.

In one embodiment, the time interval is 1 ms.

In one embodiment, the time interval is a subframe.

In one embodiment, the time interval is a slot.

In one embodiment, the first timer stops timing after being expired.

In one embodiment, the first data unit is a data unit with a minimum sequence number in the first data unit set.

In one embodiment, the sequence number is COUNT.

In one embodiment, the sequence number is a PDCP sequence number.

In one embodiment, the sequence number is an RLC sequence number.

In one embodiment, each of data units in the first data unit set is allocated an ascending continuous sequence number according to an order of being received from upper layer.

In one embodiment, each of data units in the first data unit set is allocated an ascending continuous sequence number according to an order of being transmitted to a lower layer.

In one embodiment, each of data units in the first data unit set is allocated an ascending continuous sequence number in an order of being transmitted to a peer protocol sublayer, herein, the first data unit set is a PDCP SDU, and the sequence number is COUNT.

In one embodiment, each of data units in the first data unit set is allocated an ascending continuous sequence number in an order of being transmitted to an RLC layer, herein, the first data unit set is a PDCP SDU, and the sequence number is a PDCP sequence number.

In one embodiment, each of data units in the first data unit set is allocated an ascending continuous sequence number in an order of being transmitted to a MAC layer, herein, the first data unit set is an RLC SDU, and the sequence number is an RLC sequence number.

In one embodiment, the first data unit is a data unit in the first data unit set firstly received from an SDAP.

In one embodiment, the first data unit is a data unit in the first data unit set firstly received from an RRC sublayer.

In one embodiment, the first data unit is a data unit in the first data unit set firstly transmitted to an RLC sublayer.

In one embodiment, the first data unit is a data unit in the first data unit set firstly transmitted to a MAC sublayer.

In one embodiment, the first timer is started from an SDAP sublayer or an RRC subset of the first node receiving the first data unit; the first data unit is a first PDCP SDU, and the first PDCP SDU is allocated a PDCP sequence number; the first PDCP SDU is a data unit with a smallest PDCP sequence number in the first data unit set, herein, any data unit in the first data unit set is a PDCP SDU.

In one embodiment, the first timer is started from an SDAP sublayer or an RRC subset of the first node receiving the first data unit; the first data unit is a first PDCP SDU, and the first PDCP SDU is allocated a COUNT; the first PDCP SDU is a data unit with a smallest COUNT in the first data unit set, herein, any data unit in the first data unit set is a PDCP SDU.

In one embodiment, time-domain resources occupied by transmitting the second message are used to determine a first data unit, and the first data unit is a data unit with a smallest sequence number in the first data unit set.

In one embodiment, when the second message is transmitted, the first data unit is a data unit with a smallest sequence number and not dropped.

In one embodiment, when the second message is transmitted, a timer corresponding to the first data unit is not expired; herein, the timer corresponding to the first data unit is started from the first data unit is received from an upper layer.

In one embodiment, a third message is received via the second air interface, the third message is used to determine that at least a second data unit set is correctly received.

In one embodiment, a transmitter of the third message is the second node.

In one embodiment, the third message is not an XnAP message.

In one embodiment, the third message is not transmitted via an Xn interface.

In one embodiment, the third message is a MAC sublayer message.

In one embodiment, the third message is a PHY layer message.

In one embodiment, the third message is transmitted through a Physical Backhaul Shared CHannel (PBSCH).

In one embodiment, the third message is used to indicate at least the second data unit set.

In one embodiment, the second data unit set comprises at least one data unit.

In one embodiment, whether at least one data unit in the second data unit set is transmitted via the first air interface is determined according to at least the third message.

In one embodiment, scheduling of the first node is optimized according to at least the third message.

In one embodiment, whether at least one data unit in the second data unit set is transmitted by a cell maintained by the first node at a first air interface is determined according to at least the third message.

In one embodiment, whether a transmission of at least one data unit in the second data unit set at a first air interface is delayed is determined according to at least the third message.

In one embodiment, after the first node receives the third message, the third node is triggered to transmit an RLC Status PDU, and whether at least one data unit in the second data unit set is transmitted at a first air interface is determined according to the RLC Status PDU and the third message.

In one embodiment, cache for storing the second data unit set is cleared in advance according to at least the third message.

In one embodiment, whether at least one data unit in the second data unit set is transmitted via the first air interface is implementation-related to the first node.

In one embodiment, whether at least one data unit in the second data unit set is transmitted via the first air interface is determined by the first node itself.

In one embodiment, the first node drops transmitting all data units in the second data unit set.

In one embodiment, the first node randomly selects dropping transmitting partial data units in the second data unit set.

In one embodiment, an upper layer of the first node indicates to a lower layer of the first node dropping transmitting a second data unit, and the lower layer of the first node does not transmit the second data unit to a layer lower than the lower layer of the first node, the second data unit is dropped to be transmitted; herein, the second data unit is any data unit in the second data unit set.

In one subembodiment of the above embodiment, the lower layer is an RLC sublayer, and the upper layer is a PDCP sublayer.

In one embodiment, a lower layer of the first node receives the second data unit set from an upper layer of the first node, when any data unit in the second data unit set is received, a corresponding timer is started; the second data unit set is transmitted by the first processor to the second node through the first backhaul link; when the third message is received, whether a corresponding data unit is transmitted via the first air interface is determined according to whether a timer corresponding to a data unit comprised in the second data unit set indicated by the third message is expired.

In one subembodiment of the above embodiment, when a corresponding timer is expired, a corresponding data unit is dropped to be transmitted; when a corresponding timer is not expired, a corresponding data unit is transmitted.

In one subembodiment of the above embodiment, the lower layer is a PDCP sublayer, and the upper layer is one of an SDAP sublayer or an RRC sublayer.

In one embodiment, each data unit in the second data unit set and a sequence number of the each data unit are transmitted by the first processor through the first backhaul link to the second node.

In one subembodiment of the above embodiment, a PDCP sublayer of the first node at least receives the second data unit set from an SDAP sublayer or from an RRC sublayer of the first node, the second data unit set is transmitted by the first processor through the first backhaul link to the second node, and any data unit in the second data unit set is a PDCP SDU.

In one subembodiment of the above embodiment, an RLC sublayer of the first node at least receives the second data unit set from a PDCP sublayer of the first node, the second data unit set is transmitted by the first processor through the first backhaul link to the second node, and any data unit in the second data unit set is an RLC SDU.

In one subembodiment of the above embodiment, the sequence number is COUNT.

In one embodiment, each data unit in the second data unit set is transmitted at the third air interface after being processed by an RLC sublayer, a MAC sublayer and a PHY layer protocols.

In one embodiment, the second data unit set belongs to the first radio bearer.

In one embodiment, the second data unit set does not belong to the first radio bearer.

### Embodiment 6

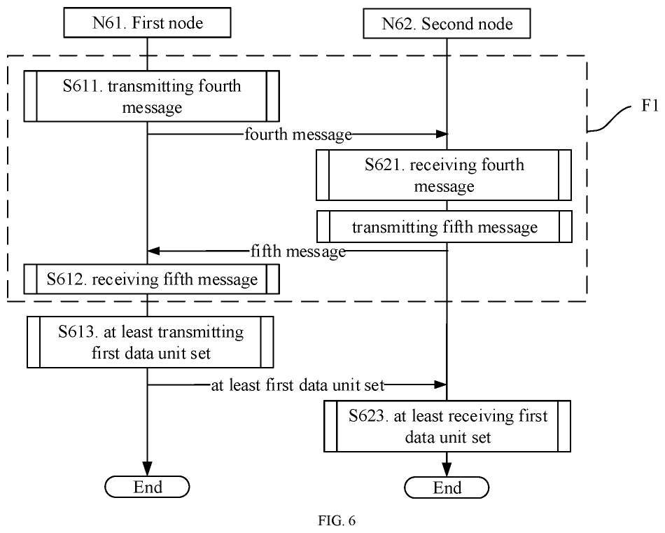

Embodiment 6 illustrates a flowchart of signal transmission on a first backhaul link according to one embodiment in the present application, as shown in FIG. 6. A first node and a second node are in communications through a first backhaul link. It is particularly underlined that the order illustrated in the embodiment does not put constraints over sequences of signal transmissions and implementations. steps in dotted box F1 are optional.

The first node N61 transmits a fourth message in step S611; receives a fifth message in step S612; at least transmits a first data unit set in step S613. It should be noted that the step S613 takes after the step S511 and before the step S514 in embodiment 5.

The second node N62 receives a fourth message in step S621; transmits a fifth message in step S622;

and at least receives a first data unit set in step S623.

In embodiment 6, a fourth message is transmitted through the first backhaul link, and the fourth message is used to indicate a first candidate resource set; herein, resources occupied by transmitting the second message belong to the first candidate resource set; a fifth message is received through the first backhaul link, and the fifth message is a response to the fourth message; herein, the fifth message is used to indicate a second candidate resource set, the second candidate resource set is a subset of the first candidate resource set, and the second candidate resource set is reserved for a transmission through the second air interface; at least the first data unit set is transmitted to a second node through a first backhaul link.

In one embodiment, at least the first data unit set is transmitted through a user plane of the first backhaul link.

In one embodiment, at least the first data unit set is transmitted through an Xn user plane (Xn-U interface) of the first backhaul link.

In one embodiment, at least the second data unit set is transmitted through a user plane of the first backhaul link.

In one embodiment, at least the second data unit set is transmitted through an Xn-U interface of the first backhaul link.

In one embodiment, the fourth message and the fifth message are transmitted through a control plane of the first backhaul link.

In one embodiment, the fourth message and the fifth message are transmitted through an Xn-C(Xn control plane) of the first backhaul link.

In one embodiment, the fourth message is an XnAP message.

In one embodiment, the fourth message is used to indicate a first candidate resource set, and the first candidate resource set comprises at least one candidate resource.

In one embodiment, any candidate resource comprised in the first candidate resource set is a radio resource.

In one embodiment, the first candidate resource set at least comprises a time-domain resource set, and the time-domain resource set at least comprises one time-domain resource.

In one embodiment, time-domain resources comprised in the first candidate resource set are periodic.

In one embodiment, the first candidate resource set at least comprises a frequency-domain resource set, and the frequency-domain resource set at least comprises one frequency-domain resource.

In one embodiment, the first candidate resource set at least comprises a beam resource set, and the beam resource set at least comprises a beam resource.

In one embodiment, one frequency-domain resource comprises at least one resource element (RE).

In one embodiment, one frequency-domain resource comprises at least one resource block (RB).

In one embodiment, one frequency domain resource comprises at least one subchannel.

In one embodiment, resources occupied by transmitting the second message belong to the first candidate resource set.

In one embodiment, resources occupied by transmitting the third message belong to the first candidate resource set.

In one embodiment, the first candidate resource set is a resource set that can be used for the second air interface transmission provided by the first node.

In one embodiment, the fifth message is an XnAP message.

In one embodiment, the fifth message is a response to the fourth message.

In one embodiment, as a response to transmitting the fourth message through the first backhaul link, a fifth message is received through the first backhaul link.

In one embodiment, the fifth message is used to indicate a second candidate resource set, the second candidate resource set comprises at least one candidate resource, and the second candidate resource set is a subset of the first candidate resource set.

In one embodiment, the second candidate resource set is a resource set that can be used by both the first node and the second node for the second air interface transmission.

In one embodiment, the second node determines the second candidate resource set from the first candidate resource set indicated by the fourth message.

In one embodiment, the second node determines the second candidate resource set by itself from the first candidate resource set indicated by the fourth message.

In one embodiment, the second node determines the second candidate resource set from the first candidate resource set indicated by the fourth message according to scheduling strategy.

In one embodiment, the second node determines the second candidate resource set from the first candidate resource set indicated by the fourth message according to cell payload.

In one embodiment, the fifth message is a confirmation message; herein, the second candidate resource set is the first candidate resource set.

In one embodiment, a format of the fifth message is the same as a format of the fourth message; herein, at least one resource in the first candidate resource set does not belong to the second candidate resource set.

In one embodiment, the second candidate resource set is reserved for a transmission via the second air interface.

In one embodiment, the second candidate resource set is reserved for a fast signaling interaction between base stations in cell coordinated communications.

In one embodiment, partial resources in the second candidate resource set are used by the first node to transmit data via the second air interface, and the remaining partial resources in the second candidate resource set are used by the first node to receive data via the second air interface.

In one embodiment of the above embodiment, resources occupied by transmitting the second message belong to the partial resources in the second candidate resource set; resources occupied by transmitting the third message belong to the remaining partial resources in the second candidate resource set.

In one embodiment of the above embodiment, the second node monitors a radio signal transmitted from the first node on the partial resources on the second candidate resource set.

In one subembodiment of the above embodiment, the first node monitors a radio signal transmitted from the second node on the remaining partial resources on the second candidate resource set.

In one embodiment, the first node and the second node negotiate to determine radio resources transmitted via the second air interface through the fourth message and the fifth message interacted on the first backhaul link.

The above negotiation process can be executed before the first node and the second node start a coordinated transmission.

The above embodiments can improve the radio resource utilization through the first backhaul link negotiation.

In one embodiment, a time for transmitting the fourth message is earlier than a time for transmitting the second message.

The above embodiments can reduce the transmission delay by negotiating in advance.

### Embodiment 7

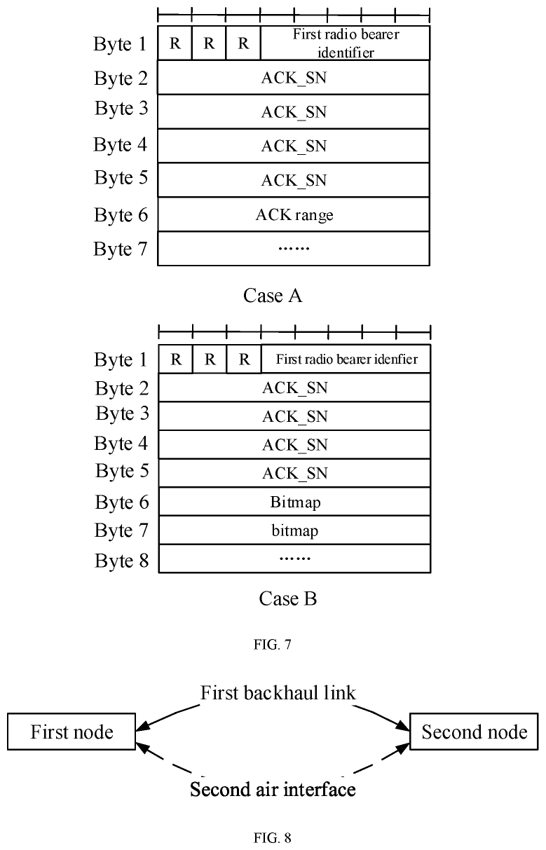

Embodiment 7 illustrates a schematic diagram of a format of a second message according to one embodiment of the present application, as shown in FIG. 7.

In one embodiment, the second message is used to at least indicate the first radio bearer and a data unit belonging to the first radio bearer.

In one embodiment, the second message comprises a sequence number set, and the sequence number set is used to indicate the first data unit set.

In one embodiment, the second message comprises a sequence number of each data unit in the first data unit set.

In one embodiment, the second message is a MAC Control Element (CE).

In one embodiment, the second message is identified by a second LCID, and the second LCID is related to the first radio bearer identifier.

In one subembodiment of the above embodiment, the first signaling comprises the second LCID.

In one embodiment, the second LCID is different from the first LCID.

In one embodiment, the second LCID is the same as the first LCID.

In one embodiment, a format of the second message is the same as a format of RLC STATUS PDU.

In one embodiment, a format of the second message is the same as a format of PDCP STATUS PDU.

In one embodiment, the second message is a PHY signaling.

In one embodiment, the second message comprises the first radio bearer identifier.

In one embodiment, the second message indicates the first data unit set through ACK_SN and ACK range; herein, the ACK_SN is used to indicate a sequence number of a data unit that is successfully received, and the ACK range is used to indicate a number of data units continuously and successfully received starting from a successfully received data unit indicated from the ACK_SN.

In one embodiment, the second message indicates the first data unit set through ACK_SN and Bitmap; herein, the ACK_SN is used to indicate a sequence number of a data unit that is successfully received, a position of any bit in the Bitmap is used to indicate an offset value between a sequence number of a data unit and a sequence number of a data unit indicated by the ACK_SN; when a value of the any bit is 0, it is indicated that a data unit corresponding to a sequence number indicated by a position of the any bit shifting from the ACK_SN is not successfully received, and when a value of the any bit is 1, it is indicated that a data unit corresponding to a sequence number indicated by the any bit shifting from the ACK_SN is correctly received; the first data unit set comprises a data unit corresponding to a sequence number indicated by any bit with a value of 1 in the Bitmap starting from ACK_SN.

In one embodiment, the ACK_SN comprises 12 bits.

In one embodiment, the ACK_SN comprises 18 bits.

In one embodiment, the ACK_SN comprises 32 bits.

In one embodiment, the first radio bearer identifier comprises 5 bits.

In one embodiment, the first radio bearer identifier comprises 6 bits.

In one embodiment, the second LCID comprises 5 bits.

In one embodiment, the second LCID comprises 6 bits.

In case A of embodiment 7, the second message comprises the first radio bearer identifier, and the first radio bearer identifier comprises 5 bits; the second message indicates the first data unit set through ACK_SN and ACK range, the ACK_SN comprises 32 bits, and the ACK range comprises 8 bits.

In case B of embodiment 7, the second message comprises the first radio bearer identifier, and the first radio bearer identifier comprises 5 bits; the second message indicates the first data unit set through ACK_SN and a bit with a value of 1 in Bitmap, and the ACK_SN comprises 32 bits.

An R bit in embodiment 7 is a reserved bit.

In one embodiment, a first ACK_SN in the second message is used to indicate a sequence number of the first data unit; herein, the second message indicates data units in the first data unit set according to an ascending sequence number.

In one embodiment, a format of the third message is the same as a format of the second message.

### Embodiment 8

Embodiment 8 illustrates a schematic diagram of a connection between a first node and a second node according to one embodiment of the present application, as shown in FIG. 8. The solid line represents a first backhaul link, the dotted line represents a radio link of a second radio interface.

In embodiment 8, the first node connects with the second node through the first backhaul link, and connects through a radio link of the second air interface with the second node.

Typically, the first backhaul link is a wired link.

In one embodiment, before communicating through the second air interface, the first node and the second node make necessary configuration through a wired backhaul link.

In one embodiment, the necessary configuration comprises transmitting time-frequency resources of the second message.

In one embodiment, the necessary configuration comprises transmitting time-frequency resources of the third message.

### Embodiment 9

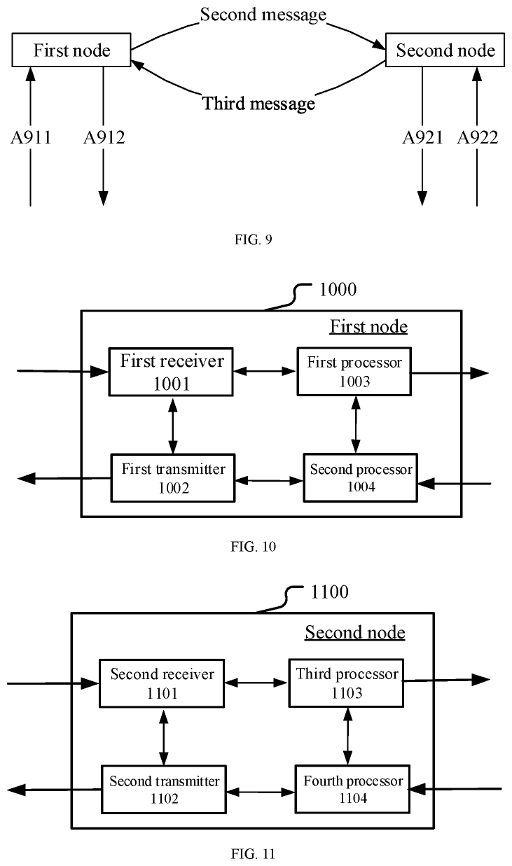

Embodiment 9 illustrates a schematic diagram of a second air interface, as shown in FIG. 9. FIG. 9 illustrates a full duplex working mode.

In one embodiment, there exists an overlapping between a transmission of the second message and an uplink reception of the first node (as shown by the arrow A911) in time, and there exists an overlapping between a reception of the second message and an uplink reception of the second node (as shown by arrow A922) in time; that is, the first node transmits the second message in a full duplex mode.

In one embodiment, there exists an overlapping between a transmission of the second message and a downlink transmission of the first node (as shown by the arrow A911) in time, and there exists an overlapping between a reception of the second message and a downlink transmission of the second node (as shown by arrow A921) in time; that is, the second node receives the second message in a full duplex mode.

In one embodiment, there exists an overlapping between a reception of the third message and an uplink reception of the first node (as shown by the arrow A911) in time, and there exists an overlapping between a transmission of the third message and an uplink reception of the second node (as shown by arrow A921) in time; that is, the second node transmits the third message in a full duplex mode.

In one embodiment, there exists an overlapping between a reception of the third message and a downlink transmission of the first node (as shown by the arrow A912) in time, and there exists an overlapping between a transmission of the third message and a downlink transmission of the second node (as shown by arrow A921) in time; that is, the first node receives the third message in a full duplex mode.

In one embodiment, the first node in the first air interface and the second node in the third air interface maintain a synchronous uplink reception or downlink transmission.

The above embodiments can effectively reduce interferences between base stations.

### Embodiment 10

Embodiment 10 illustrates a structure block diagram of a processor in a first node according to one embodiment of the present application, as shown in FIG. 10. In FIG. 10, a processor of a first node 1000 comprises a first receiver 1001, a first transmitter 1002, a first processor 1003 and a second processor 1004; the first node 1000 is a base station.

In embodiment 10, the first transmitter 1002 at least transmits a first data unit set via a first air interface; the first receiver 1001 receives a first message via the first air interface, the first message is used to determine that at least the first data unit set is correctly received; the first processor 1003 at least transmits the first data unit set to a second node through a first backhaul link; the first transmitter 1002 transmits a second message via a second air interface, the second message is used to indicate the first data unit set; herein, the second node is co-located with a receiver of the second message, and the second node and the receiver of the second message are respectively not co-located with a transmitter of the first message.

In one embodiment, the first receiver 1001 receives a third message via the second air interface, the third message is used to determine that at least a second data unit set is correctly received; the first transmitter 1002 determines whether at least one data unit in the second data unit set is transmitted via the first air interface according to at least the third message; herein, the second data unit set is transmitted by the first processor to the second node through the first backhaul link.

In one embodiment, the first processor 1003 transmits a fourth message through the first backhaul link, and the fourth message is used to indicate a first candidate resource set; herein, resources occupied by transmitting the second message belong to the first candidate resource set.

In one embodiment, the first processor 1003 transmits a fourth message through the first backhaul link, and the fourth message is used to indicate a first candidate resource set; herein, resources occupied by transmitting the second message belong to the first candidate resource set; the second processor 1004 receives a fifth message through the first backhaul link, and the fifth message is a response to the fourth message; herein, the fifth message is used to indicate a second candidate resource set, the second candidate resource set is a subset of the first candidate resource set, and the second candidate resource set is reserved for a transmission through the second air interface.

In one embodiment, a first data unit is used to determine time-domain resources occupied by the second message; herein, the first data unit is a data unit with a minimum sequence number in the first data unit set.

In one embodiment, the first transmitter 1002 transmits a first signaling via the first air interface, the first signaling is used to indicate that a data unit belonging to a first radio bearer is simultaneously received from the first node and the second node; herein, the first data unit set belongs to the first radio bearer.

In one embodiment, the first receiver 1001 comprises the receiver 418 (comprising the antenna 420), the receiving processor 470, the multi-antenna receiving processor 472 and the controller/processor 475 in FIG. 4 in the present application.

In one embodiment, the first transmitter 1002 comprises the transmitter 418 (comprising the antenna 420), the transmitting processor 416, the multi-antenna transmitting processor 471 and controller/processor 475 in FIG. 4 of the present application.

In one embodiment, the first processor 1003 comprises at least one of the transmitter 418 (comprising the antenna 420), the transmitting processor 416, the multi-antenna transmitting processor 471 or the controller/processor 475 in FIG. 4 of the present application.

In one embodiment, the first processor 1003 comprises the controller/processor 475 in FIG. 4 of the present application.

In one embodiment, the second processor 1004 comprises at least one of the receiver 418 (comprising the antenna 420), the transmitting processor 416, the multi-antenna transmitting processor 471 or the controller/processor 475 in FIG. 4 of the present application.

In one embodiment, the second processor 1004 comprises the controller/processor 475 in FIG. 4 of the present application.

### Embodiment 11

Embodiment 11 illustrates a structure block diagram of a processor in a second node according to one embodiment of the present application, as shown in FIG. 11. In FIG. 11, a processor of a second node 1100 comprises a second receiver 1101 and a second transmitter 1102, a third processor 1103 and a fourth processor 1104; the second node 1100 is a base station.

In embodiment 11, the fourth processor 1104 receives at least a first data unit set from a first node through a first backhaul link; the second receiver 1101 receives a second message via a second air interface, the second message is used to indicate the first data unit set; herein, at least the first data unit set is transmitted by the first node via a first air interface; a first message is received by the first node via the first air interface, and the first message is used to determine that at least the first data unit set is correctly received; the first node and a transmitter of the second message are co-located; the second node and a transmitter of the first message are not co-located.

In one embodiment, the second transmitter 1102 transmits a third message via the second air interface, the third message is used to determine that at least a second data unit set is correctly received; herein, at least the third message is used to determine whether at least one data unit in the second data unit set is transmitted by the first node via the first air interface; the second data unit set is transmitted by the first node to the second node through the first backhaul link.

In one embodiment, the fourth processor 1104 receives a fourth message through the first backhaul link, and the fourth message is used to indicate a first candidate resource set; herein, resources occupied by transmitting the second message belong to the first candidate resource set.

In one embodiment, the fourth processor 1104 receives a fourth message through the first backhaul link, and the fourth message is used to indicate a first candidate resource set; herein, resources occupied by transmitting the second message belong to the first candidate resource set; the third processor 1103 transmits a fifth message through the first backhaul link, and the fifth message is a response to the fourth message; herein, the fifth message is used to indicate a second candidate resource set, the second candidate resource set is a subset of the first candidate resource set, and the second candidate resource set is reserved for a transmission through the second air interface.

In one embodiment, a first data unit is used to determine time-domain resources occupied by the second message; herein, the first data unit is a data unit with a minimum sequence number in the first data unit set.

In one embodiment, a first signaling is transmitted by the first node via the first air interface, the first signaling being used to indicate that a data unit belonging to a first radio bearer is simultaneously received from the first node and the second node; herein, the first data unit set belongs to the first radio bearer; a receiver of the first signaling and the transmitter of the first message are co-located.

In one embodiment, the second receiver 1101 comprises the receiver 454 (comprising the antenna 452), the receiving processor 456, the multi-antenna receiving processor 458 and the controller/processor 459 in FIG. 4 of the present application.

In one embodiment, the second transmitter 1102 comprises the transmitter 454 (comprising the antenna 452), the transmitting processor 468, the multi-antenna transmitting processor 457 and the controller/processor 459 in FIG. 4 of the present application.

In one embodiment, the third processor 1103 comprises at least one of the transmitter 454 (comprising the antenna 452), the transmitting processor 468, the multi-antenna transmitting processor 457 or the controller/processor 459 in FIG. 4 of the present application.

In one embodiment, the third processor 1103 comprises the controller/processor 459 in FIG. 4 of the present application.

In one embodiment, the fourth processor 1104 comprises at least one of the receiver 454 (comprising the antenna 452), the receiving processor 456, the multi-antenna receiving processor 458 or the controller/processor 459 in FIG. 4 of the present application.

In one embodiment, the fourth processor 1104 comprises the controller/processor 459 in FIG. 4 of the present application.

### Embodiment 12

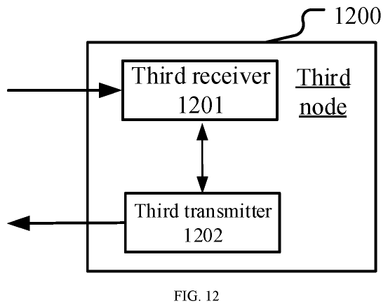

Embodiment 12 illustrates a structure block diagram of a processor in a third node according to one embodiment of the present application, as shown in FIG. 12. In FIG. 12, a processor in a third node 1200 comprises a third receiver 1201 and a third transmitter 1202.

In embodiment 12, a third receiver 1201 at least receives a first data unit set via a first air interface; a third transmitter 1202 transmits a first message via the first air interface, the first message is used to determine that at least the first data unit set is correctly received; herein, at least the first data unit set is transmitted by a first node to a second node through a first backhaul link; a second message is transmitted by the first node through a second air interface, and the second message is used to indicate the first data unit set; the second node is co-located with a receiver of the second message, and the second node and the receiver of the second message are respectively not co-located with the third node, and a receiver of the first message is the first node.

In one embodiment, a third message is received by the first node through the second air interface, the third message being used to determine that at least a second data unit set is correctly received; at least the third message is used to determine whether at least one data unit in the second data unit set is transmitted by the first node via the first air interface; herein, the second data unit set is transmitted by the first node to the second node through the first backhaul link; a transmitter of the third message and the receiver of the second message are co-located.

In one embodiment, a fourth message is transmitted by the first node to the second node through the first backhaul link, and the fourth message is used to indicate a first candidate resource set; herein, resources occupied by transmitting the second message belong to the first candidate resource set.

In one embodiment, a fourth message is transmitted by the first node to the second node through the first backhaul link, and the fourth message is used to indicate a first candidate resource set; herein, resources occupied by transmitting the second message belong to the first candidate resource set; a fifth message is transmitted by the second node to the first node through the first backhaul link, and the fifth message is a response to the fourth message; herein, the fifth message is used to indicate a second candidate resource set, the second candidate resource set is a subset of the first candidate resource set, and the second candidate resource set is reserved for a transmission through the second air interface.

In one embodiment, a first data unit is used to determine time-domain resources occupied by the second message; herein, the first data unit is a data unit with a minimum sequence number in the first data unit set.

In one embodiment, the third receiver 1201 receives a first signaling via the first air interface, the first signaling is used to indicate that a data unit belonging to a first radio bearer is simultaneously received from the first node and the second node; herein, the first data unit set belongs to the first radio bearer.

In one embodiment, the first air interface is used for radio communications between the first node and the third node.

In one embodiment, the second air interface is used for radio communications between the first node and the second node.

In one embodiment, the first backhaul link is used for communications based on an Xn interface between the first node and the second node.

In one embodiment, the third receiver 1201 comprises at least one of the receiver 454 (comprising the antenna 452), the receiving processor 456, the multi-antenna receiving processor 458 or the controller/processor 459 in FIG. 4 of the present application.

In one embodiment, the third receiver 1201 comprises the receiver 454 (comprising the antenna 452), the receiving processor 456, and the controller/processor 459 in FIG. 4 of the present application.

In one embodiment, the third receiver 1101 comprises the receiver 454 (comprising the antenna 452), the receiving processor 456, the multi-antenna receiving processor 458 and the controller/processor 459 in FIG. 4 of the present application.

In one embodiment, the third transmitter 1202 comprises at least one of the transmitter 454 (comprising the antenna 452), the transmitting processor 468, the multi-antenna transmitting processor 457 or the controller/processor 459 in FIG. 4 of the present application.

In one embodiment, the third transmitter 1202 comprises the transmitter 454 (comprising the antenna 452), the transmitting processor 468, and the controller/processor 459 in FIG. 4 of the present application.

In one embodiment, the third transmitter 1202 comprises the transmitter 454 (comprising the antenna 452), the transmitting processor 468, the multi-antenna transmitting processor 457 and the controller/processor 459 in FIG. 4 of the present application.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. A first-type communication node or a UE or a terminal in the present application includes but not limited to mobile phones, tablet computers, laptops, network cards, low-power devices, enhanced Machine Type Communication (eMTC) devices, NB-IOT devices, vehicle-mounted communication equipment, aircrafts, airplanes, unmanned aerial vehicles (UAV), telecontrolled aircrafts and other wireless communication devices. The second-type communication node or the base station or the network side device in the present application includes but is not limited to the macro-cellular base stations, micro-cellular base stations, home base stations, relay base stations, eNB, gNB, Transmission and Reception Points (TRP), relay satellites, satellite base stations, air base stations, test equipment, such as transceiver that simulates some functions of the base station, signaling tester and other wireless communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

1. A first node for wireless communications, comprising:
a first transmitter, at least transmitting a first data unit set via a first air interface;
a first receiver, receiving a first message via the first air interface, the first message being used to determine that at least the first data unit set is correctly received;
a first processor, at least transmitting the first data unit set to a second node through a first backhaul link; and
the first transmitter, transmitting a second message via a second air interface, the second message being used to indicate the first data unit set;
wherein the second node is co-located with a receiver of the second message, and the second node and the receiver of the second message are respectively not co-located with a transmitter of the first message.

2. The first node according to claim 1, comprising:
the first receiver, receiving a third message via the second air interface, the third message being used to determine that at least a second data unit set is correctly received; and
the first transmitter, determining whether at least one data unit in the second data unit set is transmitted via the first air interface according to at least the third message;
wherein the second data unit set is transmitted by the first processor to the second node through the first backhaul link.

3. The first node according to claim 1, comprising:
the first processor, transmitting a fourth message through the first backhaul link, the fourth message being used to indicate a first candidate resource set;
wherein resources occupied by transmitting the second message belong to the first candidate resource set.

4. The first node according to claim 3, comprising:
a second processor, receiving a fifth message through the first backhaul link, the fifth message being a response to the fourth message;
wherein the fifth message is used to indicate a second candidate resource set, the second candidate resource set is a subset of the first candidate resource set, and the second candidate resource set is reserved for a transmission via the second air interface.

5. The first node according to claim 1, wherein a first data unit is used to determine time-domain resources occupied by transmitting the second message;
wherein the first data unit is a data unit with a minimum sequence number in the first data unit set.

6. The first node according to claim 1, comprising:
the first transmitter, transmitting a first signaling via the first air interface, the first signaling being used to indicate that a data unit belonging to a first radio bearer is simultaneously received from the first node and the second node;
wherein the first data unit set belongs to the first radio bearer.

7. A second node for wireless communications, comprising:
a fourth processor, at least receiving a first data unit set from a first node through a first backhaul link;
a second receiver, receiving a second message via a second air interface, the second message being used to indicate the first data unit set;
wherein at least the first data unit set is transmitted by the first node via a first air interface; a first message is received by the first node via the first air interface, and the first message is used to determine that at least the first data unit set is correctly received; the first node and a transmitter of the second message are co-located; the second node and a transmitter of the first message are not co-located.

8. The second node according to claim 7, comprising:
a second transmitter, transmitting a third message via the second air interface, the third message being used to determine that at least a second data unit set is correctly received;
wherein at least the third message is used to determine whether at least one data unit in the second data unit set is transmitted by the first node via the first air interface; the second data unit set is transmitted by the first node to the second node through the first backhaul link.

9. The second node according to claim 7, comprising:
the fourth processor, receiving a fourth message through the first backhaul link, and the fourth message being used to indicate a first candidate resource set;
wherein resources occupied by transmitting the second message belong to the first candidate resource set.

10. The second node according to claim 9, comprising:
a third processor, transmitting a fifth message through the first backhaul link, and the fifth message is a response to the fourth message;
wherein the fifth message is used to indicate a second candidate resource set, the second candidate resource set is a subset of the first candidate resource set, and the second candidate resource set is reserved for a transmission via the second air interface.

11. The second node according to claim 7, wherein a first data unit is used to determine time-domain resources occupied by transmitting the second message;
wherein the first data unit is a data unit with a minimum sequence number in the first data unit set.

12. The second node according to claim 7, wherein a first signaling is transmitted by the first node via the first air interface, the first signaling being used to indicate that a data unit belonging to a first radio bearer is simultaneously received from the first node and the second node;
wherein the first data unit set belongs to the first radio bearer; a receiver of the first signaling and the transmitter of the first message are co-located.

13. (canceled)

14. A method in a first node for wireless communications, comprising:
at least transmitting a first data unit set via a first air interface;
receiving a first message via the first air interface, the first message being used to determine that at least the first data unit set is correctly received;
at least transmitting the first data unit set to a second node through a first backhaul link;
transmitting a second message via a second air interface, the second message being used to indicate the first data unit set;
wherein the second node is co-located with a receiver of the second message, and the second node and the receiver of the second message are respectively not co-located with a transmitter of the first message.

15. The method in a first node according to claim 14, comprising:
receiving a third message via the second air interface, the third message being used to determine that at least a second data unit set is correctly received;
determining whether at least one data unit in the second data unit set is transmitted via the first air interface according to at least the third message;
wherein the second data unit set is transmitted by the first processor to the second node through the first backhaul link.

16. The method in a first node according to claim 14, comprising:
transmitting a fourth message through the first backhaul link, the fourth message being used to indicate a first candidate resource set;
wherein resources occupied by transmitting the second message belong to the first candidate resource set.

17. The method in a first node according to claim 16, comprising:
receiving a fifth message through the first backhaul link, and the fifth message being a response to the fourth message;
wherein the fifth message is used to indicate a second candidate resource set, the second candidate resource set is a subset of the first candidate resource set, and the second candidate resource set is reserved for a transmission via the second air interface.

18. The method in a first node according to claim 14, wherein a first data unit is used to determine time-domain resources occupied by transmitting the second message;
wherein the first data unit is a data unit with a minimum sequence number in the first data unit set.

19. The first node according to claim 14, comprising:
the first transmitter, transmitting a first signaling via the first air interface, the first signaling being used to indicate that a data unit belonging to a first radio bearer is simultaneously received from the first node and the second node;
wherein the first data unit set belongs to the first radio bearer.

20. A method in a second node for wireless communications, comprising:
at least receiving a first data unit set from a first node through a first backhaul link; and
receiving a second message via a second air interface, the second message being used to indicate the first data unit set;
wherein at least the first data unit set is transmitted by the first node via a first air interface; a first message is received by the first node via the first air interface, and the first message is used to determine that at least the first data unit set is correctly received; the first node and a transmitter of the second message are co-located; the second node and a transmitter of the first message are not co-located.
